(19) United States
(12) Patent Application Publication
(10) Pub. No.: US 2026/0218029 A1
(43) Pub. Date: Jul. 30, 2026

(54) NANOPARTICLE-INFUSED CAMEL FAT-BASED PHASE CHANGE MATERIALS AND PREPARATION METHODS THEREOF FOR SUSTAINABLE THERMAL MANAGEMENT

(71) Applicant: University of Tabuk, Tabuk (SA)

(72) Inventors: Nacer Badi, Tabuk (SA); Saleh Ahmad Alghamdi, Tabuk (SA); Hatem Ahmad Al-Aoh, Tabuk (SA)

(21) Appl. No.: 19/459,704

(22) Filed: Jan. 26, 2026

Related U.S. Application Data
(60) Provisional application No. 63/749,806, filed on Jan. 27, 2025.

(51) Int. Cl. C09K 5/06

(52) U.S. Cl. CPC C09K 5/063

(57) ABSTRACT

Camel fat-based phase change materials (PCMs) designed for sustainable thermal management in applications such as photovoltaic (PV) panel cooling. The PCMs may be enhanced with nanoparticles, including copper, boron nitride, and carbon nanotubes. The material exhibits high latent heat of fusion, improved thermal conductivity, and enhanced operational stability through encapsulation. Various methods of preparation of the PCMs are described, including for camel fat purification, stabilization via hydrogenation, and nanoparticle infusion. The effectiveness of the PCM has been demonstrated in cooling photovoltaic panels, showcasing its potential as a renewable, biodegradable, and cost-effective solution for thermal energy storage and cooling systems.

### CROSS-REFERENCE TO RELATED APPLICATIONS

This application claims priority to and the benefit of the filing of U.S. Provisional Patent Application No. 63/749,806, entitled “NANOPARTICLE-INFUSED CAMEL FAT-BASED PHASE CHANGE MATERIALS AND PREPARATION METHODS THEREOF FOR SUSTAINABLE THERMAL MANAGEMENT,” filed on Jan. 27, 2025.

### BACKGROUND OF THE INVENTION

### Field of the Invention

The present invention relates to the field of thermal energy storage and management, with a particular focus on the development of organic phase change materials enhanced with nanomaterials for use in renewable energy systems and sustainable cooling solutions.

### Background Art

Many countries, including the United States and Saudi Arabia, have significant solar energy potential that can be utilized through photovoltaic (PV) cells. However, high ambient temperatures during the day cause solar panels to reach operating temperatures of up to 60° C. These elevated temperatures dramatically reduce the performance of solar cells and accelerate the long-term aging of PV modules. Due to the thermal sensitivity of crystalline silicon, the operating temperature of silicon solar cells has a pronounced impact on their electrical performance. As a result, overheating can shorten the lifespan of PV modules, compromise their electrical performance, and irreparably damage the cells.

Silicon-based solar cells, which dominate the PV market, are particularly sensitive to temperature increases, with their efficiency decreasing by approximately 0.5% for every degree Celsius rise in operating temperature. This thermal sensitivity can lead to compromised electrical performance, shorter module lifespans, and, in extreme cases, irreversible damage to the cells.

Furthermore, traditional silicon PV systems convert only about 20% of the incident solar energy into electricity, while the remaining 80% is converted to heat, exacerbating thermal management issues. This heat buildup further reduces the system's efficiency, particularly in arid and hot environments.

Conventional cooling techniques, such as air conditioning or refrigeration, are energy-intensive and often ineffective for improving PV performance. Cooling methods are generally categorized into two types: passive and active. Passive methods rely on natural convection or conduction and typically involve no external energy input, making them economical and environmentally friendly. Active methods, on the other hand, employ heat-generating equipment such as fans or pumps, which require energy input. While active cooling is often more effective, passive cooling is preferred in regions where cost and energy efficiency are critical factors. Hybrid systems, which combine passive and active cooling strategies, have also emerged as a promising approach. These systems often involve innovative thermal management techniques, such as air-to-liquid cooling or PCM-assisted cooling. Recent studies have also explored the use of nanofluids as heat carriers in solar PV systems. The suspension of nanoparticles in nanofluids significantly increases surface area, improving heat transfer, and reducing the thermal capacity of the fluid. Nanofluids have garnered attention for their high thermal conductivity and heat storage capacity, making them ideal for enhancing cooling performance in PV applications.

Passive cooling strategies, such as phase change materials (PCMs), offer an energy-efficient alternative by absorbing and releasing heat through phase transitions, stabilizing temperatures and enhancing system efficiency without external energy input. PCMs have high latent heat properties, making them particularly effective in thermal management applications.

The potential of PCMs lies in their ability to absorb large amounts of thermal energy while maintaining a compact volume. Consequently, PCMs have been widely used in various applications, including energy conservation in buildings, ice storage systems, heat augmentation in hot water tanks, and agricultural or industrial processes such as food storage and greenhouse temperature control. In renewable energy systems, PCMs are particularly valuable for thermal energy storage, as demonstrated in solar power plants and hybrid photovoltaic-thermal (PVT) systems.

Lower PV module operating temperatures and improved adaptability to varying cell conditions remain ultimate goals for PV thermal management. One effective solution involves the integration of PCMs at the back of the solar panel. PCMs undergo reversible, temperature-dependent phase transitions, during which they absorb or release heat. This thermal buffering mechanism is associated with latent heat, a thermodynamic property. Latent heat refers to the gain or loss of thermal energy during a phase change without any change in temperature. During this process, the heat capacity of the material exhibits discontinuity as a function of temperature.

PCMs have been widely adopted in thermal energy storage applications due to their high latent heat at phase transitions. Energy stored in PCMs during the day can be recovered when needed, such as at night. PCMs are typically classified into two main types: organic and inorganic. Organic PCMs derived from animal fats have attracted attention due to their biodegradability, abundance, and cost-effectiveness. Camel fat, in particular, exhibits excellent thermal properties, with a high energy storage capacity and stability. Its high surface tension (approximately 2-3×10⁻⁴ N/cm) gives its microstructure strong support, allowing it to maintain its shape and store up to 30 times more energy than traditional materials of equivalent mass. Camel hump fat is composed predominantly of saturated fatty acids (63.4%) and monounsaturated fatty acids (34.68%), with only 1.92% polyunsaturated fatty acids, making it an ideal organic PCM candidate. The hydrogenation process further enhances its stability by saturating unsaturated bonds, increasing its resistance to oxidation and improving its thermal performance.

Incorporating nanomaterials, such as copper nanoparticles, into PCMs has been shown to enhance their thermal conductivity and energy storage capacity. Nanoparticle-infused PCMs accelerate heat absorption and dissipation, enabling superior performance in thermal management applications. Recent advancements have demonstrated that nanomaterial-enhanced PCMs can significantly reduce operating temperatures and improve the efficiency of PV systems.

This invention builds on these advancements by developing a novel camel fat-based PCM infused with copper nanoparticles, optimized for high thermal performance and stability. This material offers a sustainable, cost-effective solution for managing thermal challenges in PV systems and other energy-intensive applications, effectively reducing panel temperatures and improving efficiency.

### BRIEF SUMMARY OF EMBODIMENTS OF THE PRESENT INVENTION

It is an object of the invention to make available a purified, hydrogenated, and encapsulated camel fat phase change material (PCM) for cooling purposes, providing a sustainable and cost-effective solution for thermal energy storage and management.

It is an object of the invention to make available a novel hybrid phase change material (PCM) comprising camel fat and nanomaterials such as copper nanoparticles, boron nitride nanoparticles, or carbon nanotubes, which significantly enhance the thermal conductivity and heat transfer efficiency of the PCM.

It is another object of the invention to provide a renewable and biodegradable phase change material with high latent heat of fusion, exceptional thermal cycling stability, and adaptability for diverse thermal energy storage and management applications.

It is an additional object of the invention to extend the application of the hybrid PCM to a wide range of thermal management systems, including but not limited to photovoltaic (PV) panel cooling, industrial cooling systems, building insulation, and energy storage devices, beyond the conventional use cases of phase change materials.

These objects and other advantages are accomplished by the unique composition and fabrication method of the present invention, directed to the preparation of camel fat-based hybrid PCMs infused with nanomaterials, as well as the encapsulation of the material for improved durability and performance, according to claims 1 to 20. The invention uniquely combines camel fat with nanomaterials to create a hybrid material that addresses the limitations of existing PCMs and provides a sustainable, cost-effective solution for advanced thermal management applications.

Embodiments of the present invention relate to a phase change material (PCM) comprising: camel fat; and nanomaterials selected from the group consisting of copper nanoparticles, boron nitride nanoparticles, and carbon nanotubes. The PCM may be encapsulated in metallized polyethylene terephthalate (MPET) to form an encapsulated PCM. The encapsulated PCM may demonstrate thermal cycling stability for at least 200 cycles without significant degradation in latent heat of fusion or melting temperature. The nanomaterials may be dispersed in the camel fat at concentrations ranging from about 2 wt % to about 5 wt %. The nanomaterials may comprise copper nanoparticles with an average size of about 20 nm to about 800 nm. The nanomaterials may comprise boron nitride nanoparticles with an average size of about 20 nm to about 800 nm. The nanomaterials may comprise carbon nanotubes. The latent heat of fusion of the PCM may range from about 140 J/g to about 180 J/g. The melting temperature of the PCM may range from about 60° C. to about 78° C. The copper nanoparticles may improve the heat absorption and dissipation rate of the PCM by increasing the effective thermal conductivity of the PCM by at least 50% compared to pure camel fat.

Embodiments of the present invention also relate to a method of making a phase change material (PCM), the method comprising: purifying camel fat; hydrogenating the camel fat; and infusing nanomaterials into the camel fat. The step of purifying the camel fat may comprise rendering the camel fat with distilled water at approximately 90° C., followed by filtration and drying in a vacuum oven at about 65° C. The step of hydrogenating the camel fat may comprise reacting it with hydrogen gas at about 150 to about 250 psi and about 90° C. in the presence of a nickel catalyst to enhance its thermal stability. The step of infusing the nanomaterials may comprise dispersing the nanomaterials in the camel fat at concentrations ranging from about 2% to about 5% wt % using ultrasonic homogenization power of about 225 to about 450 W for about 10 to about 30 minutes. The step of infusing the nanomaterials may comprise introducing the nanomaterials at different concentrations to tailor the thermal conductivity and melting point of the PCM for specific applications. The step of infusing the nanomaterials may comprise increasing the thermal conductivity of the PCM by at least about 50% compared to pure camel fat. The method may further comprise encapsulating the PCM in metallized polyethylene terephthalate (MPET). The method may further comprise attaching the encapsulated PCM to photovoltaic (PV) panels. The method may further comprise incorporating the encapsulated PCM into a cooling system designed for solar energy installations, a refrigeration system, or other thermal management systems. The method may further comprise shaping the encapsulated PCM into modular forms to coordinate with photovoltaic (PV) panels, thermal management systems or temperature-sensitive cooling applications. The method may further comprise incorporating the encapsulated PCM in battery thermal management systems to regulate battery temperature during charging and discharging cycles. The step of purifying the camel fat may comprise rendering it with distilled water at approximately 90° C., followed by filtration and drying in a vacuum oven at about 65° C. The step of infusing the nanomaterials may comprise dispersing the nanomaterials in the camel fat at concentrations ranging from about 2% to about 5% wt % using ultrasonic homogenization power of about 225 to about 450 W for about 10 to about 30 minutes.

Embodiments of the present invention also relate to a phase change material (PCM) comprising camel fat, wherein the PCM exhibits a latent heat of fusion of about 120 to about 140 J/g and a melting temperature of about 55° C., wherein the PCM is encapsulated in metallized polyethylene terephthalate (MPET) shaped in a modular form capable of integration into thermal management systems or temperature-sensitive cooling applications.

Objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A and 1B are photographs showing encapsulated purified camel fat, according to an embodiment of the present invention;

FIG. 2 is a photograph showing an experimental setup of cooling validation of PV panels, according to an embodiment of the present invention;

FIG. 3 is a photograph showing cooling packs loaded with camel fat based PCM, according to an embodiment of the present invention;

FIG. 4 is an SEM image of camel fat infused with copper nanoparticles, according to an embodiment of the present invention;

FIG. 5 is an FTIR spectra for camel fat infused with copper nanoparticles, according to an embodiment of the present invention;

FIG. 6 is a graph showing differential scanning calorimetry (“DSC”) data for bare camel fat for five heating cycles at temperatures up to 150° C., according to an embodiment of the present invention;

FIGS. 7A-7C are graphs showing DSC data for bare young camel fat for five heating cycles at temperatures of 200° C., 250° C., and 300° C., respectively, according to an embodiment of the present invention;

FIG. 8 is a graph showing DSC data for a first heating cycle for bare camel fat at temperatures up to 300° C., according to an embodiment of the present invention;

FIG. 9 is a graph showing DSC data for pure camel fat for five heating cycles at temperatures up to 120° C., according to an embodiment of the present invention;

FIG. 10 is a graph showing DSC data for hybrid pure camel fat mixed with copper nanoparticles for five heating cycles at temperatures up to 120° C., according to an embodiment of the present invention;

FIG. 11 is a graph showing back temperatures for uncooled and PCM cooled PV panels, according to an embodiment of the present invention;

FIG. 12 is a graph showing front temperatures for uncooled and PCM cooled PV panels, according to an embodiment of the present invention;

FIGS. 13A and 13B are graphs showing the difference in front and back temperatures for uncooled and PCM cooled PV panels, respectively, according to an embodiment of the present invention;

FIG. 14 is a graph showing the open-circuit voltage as a function of temperature for uncooled and PCM cooled PV panels, according to an embodiment of the present invention;

FIG. 15 is a graph showing the maximum power as a function of temperatures for uncooled and PCM cooled PV panels, according to an embodiment of the present invention.

### DETAILED DESCRIPTION OF THE INVENTION

The present invention is directed to a novel hybrid phase change material (PCM) based on camel fat infused with nanomaterials, such as copper nanoparticles, boron nitride nanoparticles, or carbon nanotubes. This innovative hybrid PCM is suitable for low to moderate temperature applications, offering significant advancements in thermal energy storage and thermal management. The invention provides detailed methodologies for the preparation, characterization, and integration of this material into various systems. Below is a description of various embodiments of the invention, including experimental examples and applications thereof.

### 1. MATERIALS AND PREPARATION

### Purification of Camel Fat

Camel fat, selected for its high latent heat of fusion and stability, undergoes a purification process to remove impurities to the desired purification. Preferably, raw camel fat is rendered with an equal volume of distilled water at about 90° C. The melted fat is filtered using cheesecloth and fine gauze, separated, and dried in a vacuum oven at about 65° C. for about 8 hours. The purified camel fat forms the base material for the PCM. Purification may be achieved in other ways as well, for example by one or more physical, chemical, or enzymatic processes, including but not limited to rendering, melting, filtration, centrifugation, phase separation, washing, deodorization, bleaching, winterization, or combinations thereof. As used throughout this patent application, the terms “purified”, “pure”, “purification” shall not be interpreted to require absolute purity of the subject substance, but only that level of purity that a person of ordinary skill in the art would consider adequate for the intended purpose.

### Hydrogenation of Camel Fat

To improve thermal stability, the camel fat is hydrogenated, preferably in a high-pressure reactor. Approximately 2 kg of purified camel fat is mixed with about 0.02% nickel catalyst by weight, and hydrogen gas is introduced at a pressure of about 150 to about 250 psi at about 90° C. for about 36 hours. Hydrogenation in this manner reduces unsaturated fatty acids, enhancing oxidation resistance and thermal performance. As used throughout this patent application, the terms “hydrogenate” and “hydrogenation” shall not be limited to a particular method of hydrogenation, but may refer to any method of hydrogenation, and shall not require a certain level of hydrogenation but only that level of hydrogenation that a person of ordinary skill in the art would consider adequate for the intended purpose.

### Infusion of Nanomaterials

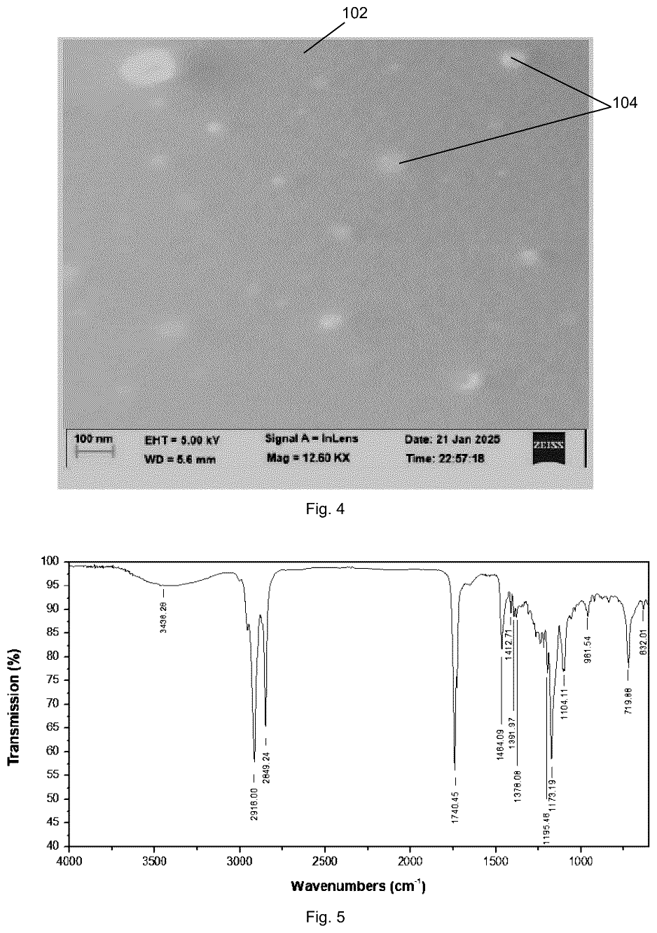

Nanomaterials are preferably infused into the hydrogenated camel fat to enhance its thermal conductivity. Such nanomaterials preferably include, but not limited to, copper nanoparticles, boron nitride nanoparticles, carbon nanotubes, and/or any combination thereof. The fat is preferably heated to about 50° C., and nanomaterials are added at about 2% to about 5% by weight. Ultrasonic homogenization at about 450 W for about 10 to about 30 minutes ensures a uniform dispersion of nanoparticles, critical for consistent thermal performance. FIG. 4 illustrates an SEM image of camel fat 102 infused with copper nanoparticles 104, illustrating the dispersion of the nanoparticles across the fat matrix.

### 2. ENCAPSULATION

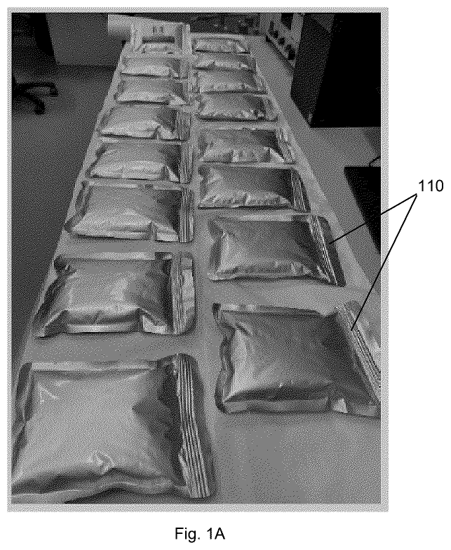

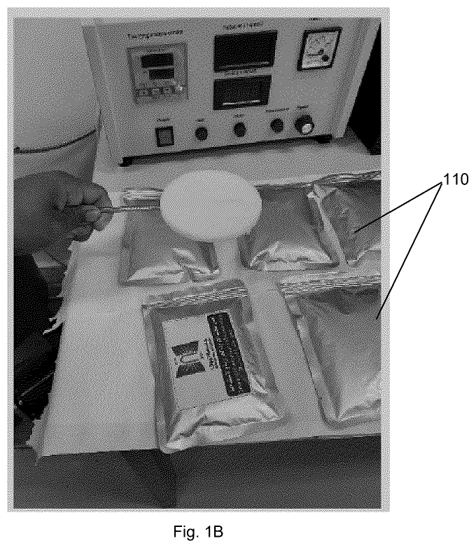

To prevent leakage and maintain operational stability, the hybrid PCM is preferably encapsulated in pouches 110, preferably pouches comprising metallized polyethylene terephthalate (MPET), for example as illustrated in FIGS. 1A and 1B. Such encapsulation can be accomplished in any manner capable of containing the PCM, for example in pouches, containers, modules, packs, bags, etc. As used herein, the terms “encapsulate”, “encapsulating” and “encapsulation” etc. shall not require that each molecule or element of the PCM itself be encapsulated, but can mean that some amount of the PCM is disposed in or at least partially surrounded by the encapsulating object. As used herein, the term “pouch(es)” shall mean any manner of containing or holding the subject material and shall not be limited to a particular type of container, including but not limited to bags, modules, containers, packs, etc., all of which terms may be used interchangeably herein. The molten PCM is dispensed into pouches 110, heat-sealed, and cooled to form compact, leak-proof modules. Encapsulation ensures durability and facilitates easy integration into various applications.

### 3. THERMAL AND STRUCTURAL CHARACTERIZATION

Thermal analysis using differential scanning calorimetry (DSC) reveals a latent heat of fusion of about 140 to about 180 J/g, depending on the nanomaterial type and concentration. The melting temperature ranges from about 60° C. to about 78° C. Fourier-transform infrared (FTIR) spectroscopy confirms the compatibility of camel fat with nanomaterials, while scanning electron microscopy (SEM) shows a uniform nanoparticle dispersion within the PCM matrix. Thermal cycling tests demonstrate exceptional durability, with minimal degradation over 200 cycles.

### 4. EXAMPLES

Example 1: Purification of Camel Fat. Raw camel fat was rendered with distilled water (1:1 ratio) at 90° C. The molten fat was filtered through cheesecloth and fine gauze to remove impurities. The purified fat layer was separated and dried in a vacuum oven at 65° C. for 8 hours.

Example 2: Hydrogenation of Camel Fat. Purified camel fat (2 kg) was mixed with 0.02% nickel catalyst by weight in a high-pressure reactor. Hydrogen gas was introduced at 150 to 250 psi, and the mixture was maintained at 90° C. for 36 hours. Periodic samples were taken to monitor the iodine value, ensuring complete saturation of unsaturated fatty acids.

Example 3: Infusion of Copper Nanoparticles into Camel Fat. Hydrogenated camel fat was heated to 50° C., and 5 wt % of copper nanoparticles (average size ~40 nm) was added. The mixture was ultrasonicated at 450 W for 30 minutes to achieve uniform dispersion of the nanoparticles within the fat matrix.

Example 4: Infusion of Boron Nitride Nanoparticles. Hydrogenated camel fat was heated to 50° C., and 3 wt % of boron nitride nanoparticles (average size ~100 nm) was added. Ultrasonic homogenization was performed for 20 minutes to ensure even distribution.

Example 5: Infusion of Carbon Nanotubes into Camel Fat. Hydrogenated camel fat was heated to 50° C., and 2 wt % of carbon nanotubes was gradually added. The mixture was ultrasonicated for 25 minutes, ensuring homogeneous dispersion.

Example 6: Encapsulation of Hybrid PCM. Molten hybrid PCM (150 g) was poured into metallized polyethylene terephthalate (MPET) pouches. The pouches were heat-sealed and cooled at room temperature, forming compact, leak-proof modules with a thickness of approximately 3 mm.

Example 7: Application of PCM for Solar Panel Cooling. Encapsulated PCM modules were attached to the back surface of a 50 W photovoltaic (PV) panel using heat-conductive tape. Under simulated solar irradiation using halogen lamps, the PCM reduced the panel temperature by 16.7° C., improving power output by approximately 20%.

### 5. APPLICATIONS

The camel fat-based hybrid PCM is particularly suitable for low to moderate temperature applications, offering significant cost and energy savings. Key applications include:
1. Solar Panels: The PCM is a cost-effective solution for cooling photovoltaic panels, significantly reducing operating temperatures and improving efficiency. This technology is highly attractive to investors in solar energy systems, as it enhances power output and increases the productivity of solar power plants.
2. Cooling Vests: The PCM can be incorporated into cooling vests for workers, athletes, or individuals with medical conditions requiring temperature regulation, providing effective and prolonged cooling in hot environments.
3. Cooling Mattresses and Bedding: PCM-integrated mattresses, toppers, and pillows regulate body temperature during sleep, promoting better sleep quality in warm climates.
4. Refrigeration Systems: The PCM enhances refrigeration system efficiency by storing and releasing cooling energy during compressor cycles, reducing energy consumption and operational costs.
5. Automotive Cooling Systems: PCM modules in automotive cabins regulate interior temperatures, reducing air conditioning use and extending battery life in electric vehicles.

### Additional Examples

Embodiments of the present invention include the various examples described throughout this application and below.

### Example 1

Camel hump fat is not pure in its raw form. It contains various impurities such as connective tissues, blood vessels, and other organic materials. Additionally, it contains different types of lipids, including triglycerides, free fatty acids, phospholipids, and other minor components. Purifying camel fat involves removing impurities and unwanted substances to ensure its suitability for various applications. The key processes involved are rendering and fine filtration. In this study no degumming, bleaching, and deodorization was carried out. Approximately 5 kg of raw camel fat was chopped into small, uniform pieces to ensure even melting. The fat was then placed in a large pot, mixed with distilled water in a 1:1 ratio by weight, and heated slowly over low to medium heat up to 90 C. It is essential to avoid high temperatures to prevent burning or altering the fat's properties. As the fat melted, it was stirred occasionally for about 2 hours to ensure even liquefaction. Once fully melted, the fat was poured through a cheesecloth into a clean container to remove solid impurities, such as connective tissue and muscle fibers. After straining, the fat was allowed to cool and solidify, which facilitated handling in the subsequent purification steps. The second step is filtering the fat to remove smaller particles and impurities that may have passed through the initial straining process. A finer gauze was placed inside a funnel, positioned over a clean container. The solidified fat was gently reheated until it became liquid again. The melted fat was then poured through the filter to further purify it. This filtering process was repeated multiple times to achieve a high level of purity, ensuring the fat was free of residual impurities. The final step is separation of fat from water. Once the fat and water mixture has cooled, the fat will solidify on top, while the water and any remaining impurities will settle at the bottom. After the fat has solidified, it can be easily lifted off, leaving the water and residue behind. This separation ensures that the purified camel fat is free from unwanted water and other impurities without compromising its beneficial properties. The purified fat was then dried in a vacuum oven at 65° C. for 8 hours to remove residual moisture. The resulting material was placed in airtight containers and stored in a refrigerator for subsequent processing.

### Example 2

The hydrogenation of camel fat is a chemical process that converts unsaturated fats into saturated fats by adding hydrogen atoms. This modification enhances the stability of the fat and solidifies it at room temperature, making it more suitable for various applications. All reactions were carried out in the hydrogenation reactor at a hydrogen pressure of 150-250 psi. Typically, a load of about 2000 g of pure camel fat with 0.02% (40 g) nickel (Ni) catalyst is loaded into the reactor. The heating control was set to maintain the temperature at approximately 90° C., and the stirring was adjusted to achieve effective mixing of the fats and solid Ni catalyst. The mixture is melted and mixed thoroughly on a stirrer/heating plate before being loaded into the reactor to occupy approximately 50% of the total internal volume with the remaining space being hydrogen gas. During the first experiments, we identified the conditions leading to complete hydrogenation. Samples of about 2 g each were collected at intervals of 12 hours, 24 hours and 36 hours at which the product was completely hydrogenated to the desired degree. The degree of saturation in fatty acids was assessed through iodine value (IV) determination method. The iodine value is a measure of the degree of unsaturation in fats and oils, indicating the amount of iodine (in grams) that can react with 100 grams of fat. It provides an estimate of the degree of unsaturation by quantifying the double bonds present in the fats, which also indicates the extent of completion of the hydrogenation process. Fats with a high iodine value are typically softer or liquid and are less stable to oxidation. The iodine value of the samples was determined according to the standard method ASTM D5554-15.

### Example 3

Copper nanoparticles (CuNPs), with an average size of approximately 40 nm, were infused into hydrogenated camel fat through ultrasonic homogenization. A 450 W U.S. Solid ultrasonic homogenizer was utilized to dissolve and disperse the CuNPs in the melted fat. Ultrasonic processors generate high-frequency sound waves, creating microscopic cavitation bubbles in liquids that collapse to produce intense localized mixing. This process effectively breaks up nanoparticle agglomerates and ensures uniform dispersion. The procedure involved heating camel fat to a liquid state at approximately 50° C. Once liquefied, the metal nanoparticles were gradually added while ultrasonic energy was applied for 10 to 30 minutes. The power output of the ultrasonic homogenizer was maintained between 40% and 80% of its maximum capacity of 450 W. Sonication continued until the nanoparticles were thoroughly and evenly dispersed in the camel fat. This solvent-free approach is efficient and preserves the properties of both the nanoparticles and the fat. Concentrations ranging from 2% to 5% by weight were found to optimize the thermal and mechanical properties of the composite without compromising its stability.

### Example 4

The hydrogenated fat samples were subjected to structural and thermal characterizations. Scanning Electron Microscopy (SEM) provided information on the surface morphology and associated changes in the microstructures of the samples under different processing conditions. It was used to assess the dispersion and distribution of copper nanoparticles within the camel fat matrix. Fourier transform infrared spectroscopy (FTIR) analysis revealed solid fat components. FTIR spectra helped in identifying functional groups and interactions between camel fat and fused copper nanoparticles. The thermal properties including heat storage capabilities of the processed hydrogenated camel fat were investigated by using differential scanning calorimetry (DSC) technique. It was carried out to identify the thermal energy storage and latent heat associated with the phase change.

### Example 5

The CuNPs-infused PCM was encapsulated in silver-laminated metallized polyethylene terephthalate (MPET) pouches. Prior to encapsulation, air bubbles were removed from the CuNPs-infused PCM using a vacuum mixer with a vacuum degree of −0.08 MPa. The removal of air bubbles was critical, as their presence could diminish the cooling performance of the encapsulated PCM.

Before dispensing the fat into the pouches, the camel fat was first heated to melt completely and then weighed to ensure each pouch contained approximately 150 g of the material. The pouches were filled in a vertical position with the melted fat and subsequently cooled in a refrigerator to solidify the fat. This step prevented spillage during the heat-sealing process, during which the pouches were set in a horizontal position. After sealing, the pouches were placed flat on a horizontal surface to ensure the faces of the pouches remained flat as shown in FIG. 1A. This configuration facilitates their placement on the back of the PV panels and ensures good thermal contact, optimizing the cooling efficiency. The heat-sealing process ensured the stability of the pouches and prevented leakage during repeated thermal cycles.

### Example 6

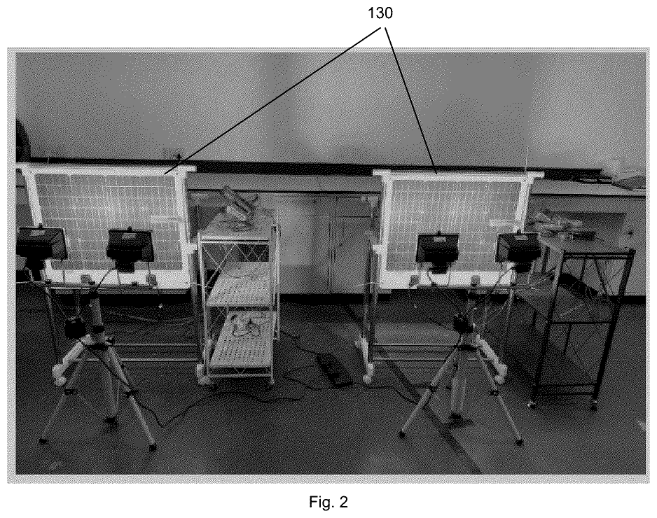

The setup involved two identical 50 W PV panels 130 (MESM-50 W) as shown in FIG. 2. One panel had encapsulated camel fat phase change material (PCM) bags 110 attached to its back for cooling, while the other served as a reference without cooling. Illumination and heating were provided by two twin halogen telescopic lamps rated at 500 W each, simulating solar exposure. Temperature sensors were mounted at identical locations on the front and back surfaces of both panels to record thermal data. Electrical parameters—including open-circuit voltage (Voc), maximum power point (MPP), short-circuit current (Isc), and maximum power current (Imp)—were measured using a solar panel MPPT tester (Jerss Solar Panel Multimeter, 12 to 60V EY1600 W). To ensure uniform testing conditions, the panels and lamps were positioned identically. Data was collected every five minutes over a 30-minute period, capturing surface temperatures and electrical outputs for both panels. The collected data were analyzed to compare the performance of the PCM-cooled panel to the non-cooled panel.

It is important to note that the twin halogen lamps did not provide the standard test condition (STC) of 1,000 W/m² illumination, and the light distribution across the PV panel surfaces was not uniform. While the lamps produced an output of approximately 12 W, significantly lower than the panel's rated 50 W, the setup was designed to facilitate relative performance comparisons. For example, the rated short-circuit current (Isc) of 3 A was reduced to about 0.6 A under lamp illumination. Despite these limitations, the setup effectively demonstrated the relative performance differences between the PCM cooled and non-cooled panels.

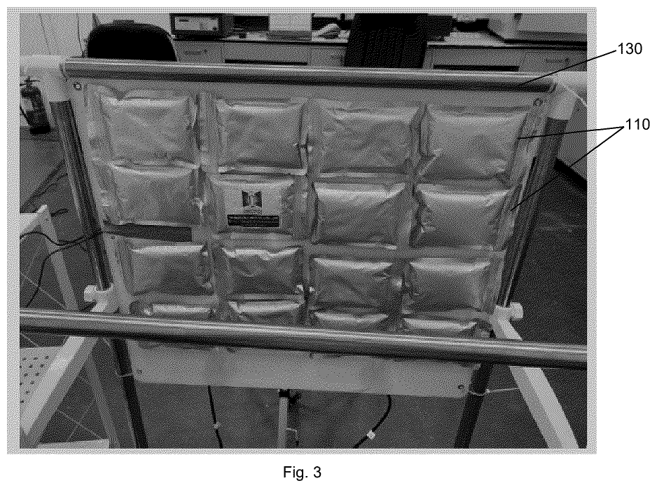

The encapsulated phase change material (PCM) was tested on photovoltaic panels under twin halogen illumination. A layer of cooling material, composed of camel fat-FIG. 2. Setup of the cooling validation on PV based PCM packs, was mounted on the back of the PV panel to passively lower its operating temperature. The setup, including the PCM packs, is illustrated in FIG. 3.

The back of one MESM-50 W solar panel (SunPower-Germany Flexible Mono Silicon, 36 cells in a 3×12 configuration, dimensions: 605 mm×505 mm×3 mm) mounted on a vertical structure was covered with camel fat-based PCM cooling packs. To reduce thermal contact resistance between the PV back surface and the PCM pouches, as well as to maximize heat transfer, a double-sided thermally conductive tape with removable adhesive on both sides was used to secure the PCM packs. This specialized heat-resistant polyimide tape, manufactured by LLP International Group, is composed of fiberglass with heat-conductive ceramic powder and has a thermal conductivity coefficient of 1.5 W/m-K. Commonly used as heat sink strips to support electronic components, this tape significantly improves the PV/PCM system's overall performance by reducing thermal contact resistance. The selected tape is highly flexible, allowing it to accommodate mechanical strain caused by the expansion and compression of the PCM without compromising heat transfer efficiency. Approximately 16 PCM packs (each measuring 102.7 mm×152.4 mm, weighing 150 g) were attached to the back of the PV panel using this double-sided thermally conductive tape. The tape's strong acrylic adhesive, with a bonding strength of approximately 360 g/cm², securely held the PCM pouches in place, ensuring durability and consistent thermal performance. Its operating temperature range is −20° C. to 120° C. A second identical MESM-50 W PV panel, positioned adjacent to the first, was used as a reference for comparison purposes.

### Example 7

FIG. 4 shows a typical SEM image of camel fat infused with copper nanoparticles, illustrating the dispersion of the nanoparticles across the fat matrix. While the image displays the structural characteristics of both the organic fat and the copper nanoparticles, it is important to note that obtaining clear images of the copper nanoparticles within the camel fat host presented a significant challenge. During SEM imaging, the fat matrix tended to melt and shift under the electron beam, resulting in instability and dull images, which hindered precise visualization of the nanoparticles. Additionally, the image reveals some spots with agglomeration of nanoparticles, indicating localized clustering within the matrix.

### Example 8

Fourier Transform Infrared (FTIR) spectroscopy was employed to examine the structural and chemical characteristics of camel fats infused with copper nanoparticles. Camel fats, predominantly composed of triglycerides and fatty acids, exhibit distinct vibrational modes that are well-documented in the literature. The FTIR spectrum of camel fats as shown in FIG. 5 reveals significant absorption bands around 2920-2950 cm⁻¹ and 2850-2870 cm⁻¹, which correspond to the asymmetric and symmetric stretching vibrations of methylene (—CH₂) groups, respectively. These peaks are indicative of the long aliphatic hydrocarbon chains characteristic of the fatty acids present in the fats.

The ester functional groups within triglycerides are represented by a sharp carbonyl (C═O) stretching vibration, typically observed between 1730-1750 cm⁻¹. This band is a key marker of the ester bonds in fats and oils. Additionally, bending vibrations of methylene (—CH₂) and methyl (—CH₃) groups are seen around 1460-1470 cm⁻¹, while the C—O stretching of ester bonds is observed in the region of 1170-1250 cm⁻¹. Furthermore, the broad absorption band observed between 3200-3600 cm⁻¹ is attributed to O—H stretching vibrations. This broad band may arise from free hydroxyl groups or moisture present in the fat matrix, reflecting the presence of adsorbed water or some residual hydroxyl functionalities.

The introduction of copper nanoparticles leads to the possibility of interactions between the nanoparticles and the camel fat matrix, potentially altering the FTIR profile. While copper itself does not exhibit significant FTIR peaks due to its metallic nature, any oxidation of the copper nanoparticles, such as the formation of copper oxides (CuO or Cu₂O), can result in additional peaks. These would typically appear in the region of 500-650 cm⁻¹ and are attributed to Cu—O stretching vibrations. Additionally, interactions between the copper nanoparticles and the fat matrix could induce shifts in the characteristic peaks of camel fats, such as the C═O stretching vibration, suggesting the possibility of coordination or surface adsorption effects.

### Example 9

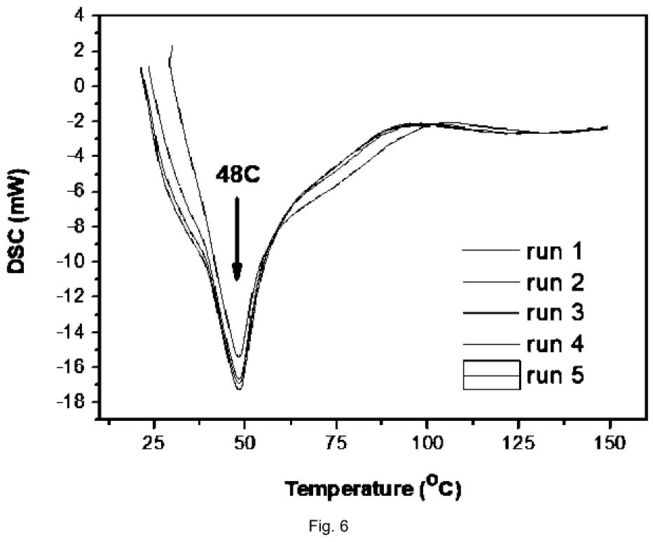

Differential Scanning calorimetry (DSC) analysis was conducted to evaluate the thermal properties of camel fat under varying conditions. The study examined the thermal stability, maximum fusion temperatures, and latent heat storage capacities of bare camel fat, purified camel fat, and hybrid camel fat (camel fat mixed with copper nanoparticles). FIGS. 6-12 summarize the results of these analyses.

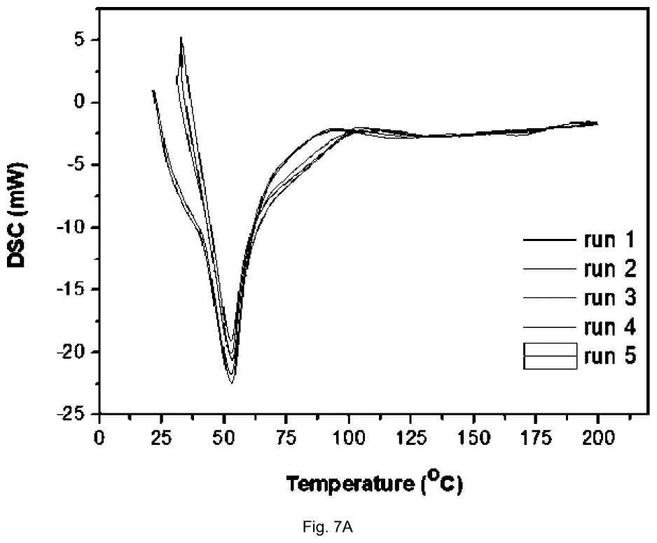

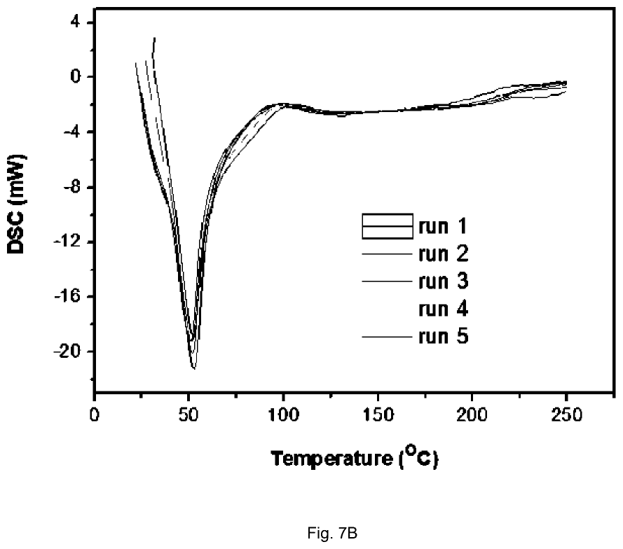

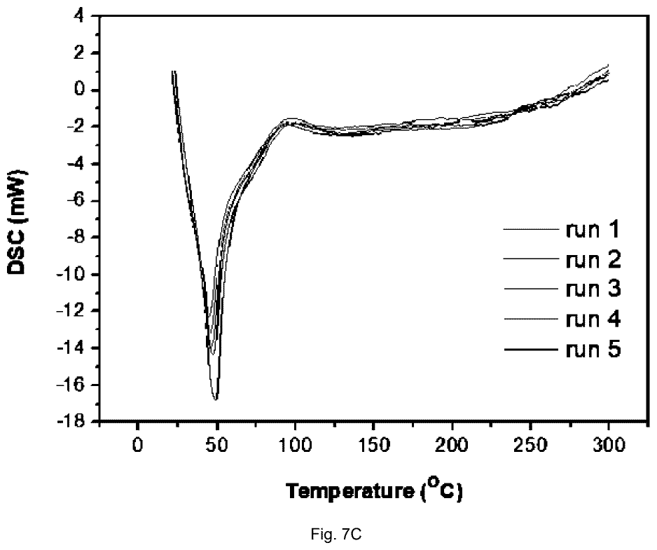

The DSC results for bare camel fat subjected to five thermal cycles, with temperatures ranging up to 150° C., are shown in FIG. 6. The camel fat exhibited stable phase transitions across the cycles, with minimal hysteresis. The maximum fusion temperature of bare camel fat was recorded at approximately 48° C., and the latent heat capacity was measured at 90-100 J/g, confirming its effectiveness as a phase change material (PCM) for low-temperature applications. The thermal behavior of young camel fat at higher temperatures revealed progressive changes in stability. As shown in FIG. 7A, young camel fat exposed to five cycles at a maximum temperature of 200° C. exhibited consistent phase transitions, with a maximum fusion temperature of 52° C. and a latent heat capacity of 100-110 J/g. When the temperature increased to 250° C. (FIG. 7B), the latent heat decreased slightly, and at 300° C. (FIG. 7C), partial thermal degradation was observed. These results indicate that bare camel fat retains significant latent heat and moderate thermal stability, even at elevated temperatures, making it suitable for medium-temperature thermal energy storage.

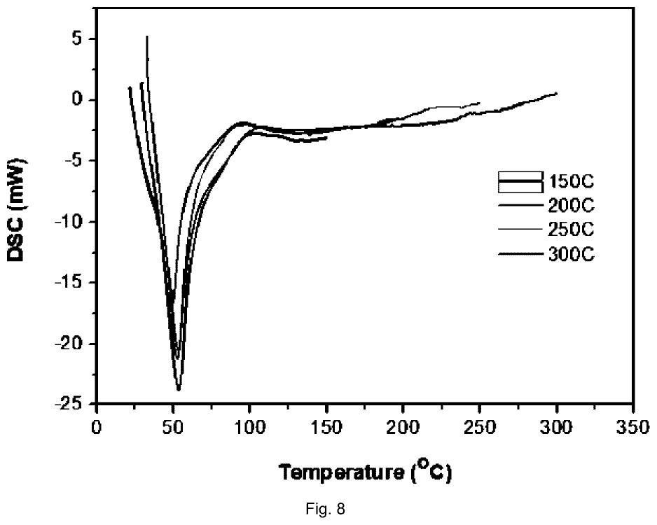

The DSC results for the first heating cycles of bare young camel fat at 150° C., 200° C., 250° C., and 300° C. are presented in FIG. 8. The latent heat capacity was highest during the first cycle at 200° C. (105 J/g) and decreased as the temperature increased to 250° C. (95 J/g) and 300° C. (90 J/g). This trend highlights the material's optimal performance at moderate operating temperatures, with diminishing efficiency at higher temperatures due to partial thermal breakdown.

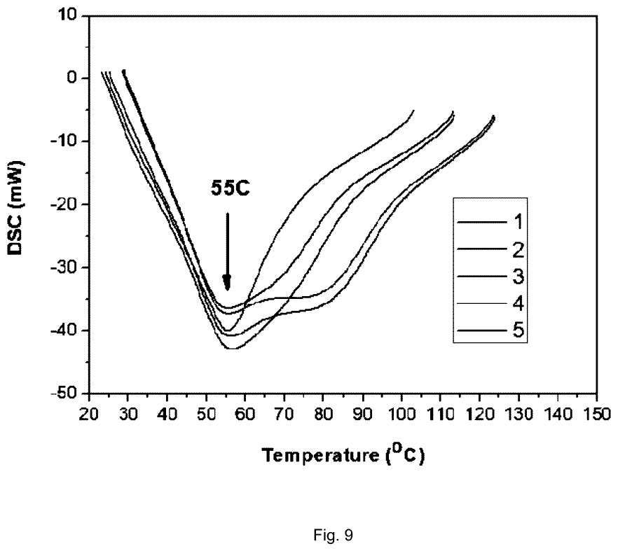

The thermal performance of purified camel fat was evaluated under temperature cycles up to 120° C., as shown in FIG. 9. Compared to bare camel fat, the purified sample demonstrated improved thermal stability and more consistent phase transitions. The maximum fusion temperature of purified camel fat was observed at 55° C., and the latent heat capacity was measured at 120-140 J/g, significantly higher than that of bare fat. This improvement can be attributed to the removal of impurities, which enhances the material's ability to store and release thermal energy efficiently. These properties make purified camel fat a promising candidate for low-temperature PCM applications.

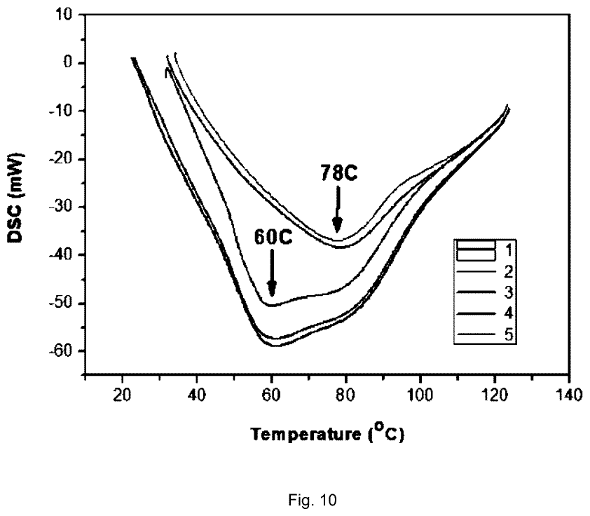

The hybrid material, comprising purified camel fat mixed with 5% copper nanoparticles, demonstrated notable enhancements in thermal performance. As shown in FIG. 10, the hybrid material was tested under thermal cycles up to 120° C. and exhibited superior thermal conductivity with more pronounced phase transitions compared to the pure sample. The maximum fusion temperature of hybrid camel fat increased progressively with thermal cycles. For the first three cycles, the fusion temperature was approximately 60° C., while in the last two cycles, it rose to 78° C. The latent heat capacity of hybrid camel fat was measured at 140-180 J/g, surpassing that of both bare and purified camel fat. The gradual increase in fusion temperature across the cycles is not yet clearly understood and requires further investigation to determine its underlying cause. The addition of copper nanoparticles improved heat transfer efficiency and facilitated faster energy absorption and release during phase transitions, highlighting its potential for advanced thermal energy storage systems.

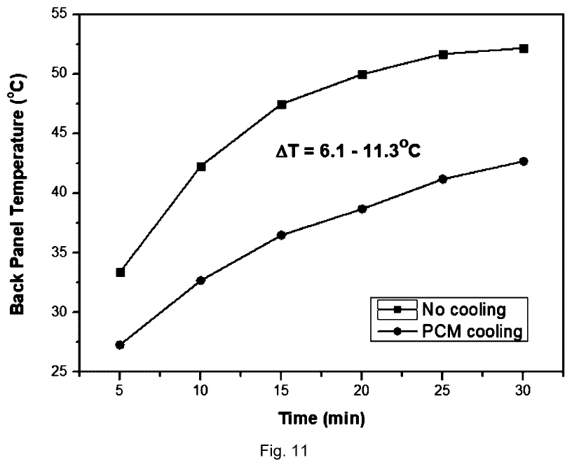

The integration of camel fat-based phase change materials (PCM) demonstrated substantial improvements in the thermal management of photovoltaic (PV) panels. Analyses of the temperature profiles revealed significant differences between cooled and uncooled panels. For the back panel temperatures, as illustrated in FIG. 11, the observed range for non-cooled and PCM-cooled panels was between 6.11° C. to 11.3° C., highlighting the PCM's ability to maintain lower back temperatures effectively.

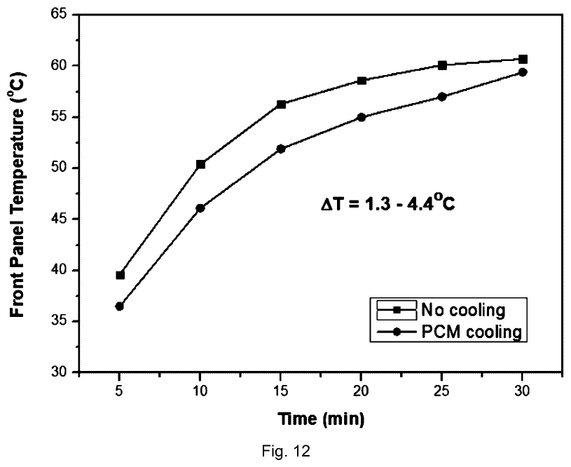

Similarly, the front panel temperatures, shown in FIG. 12, were reduced to a range of 1.3° C. to 4.4° C. for PCM-cooled panels compared to non-cooled ones, further underscoring the thermal benefits of PCM integration.

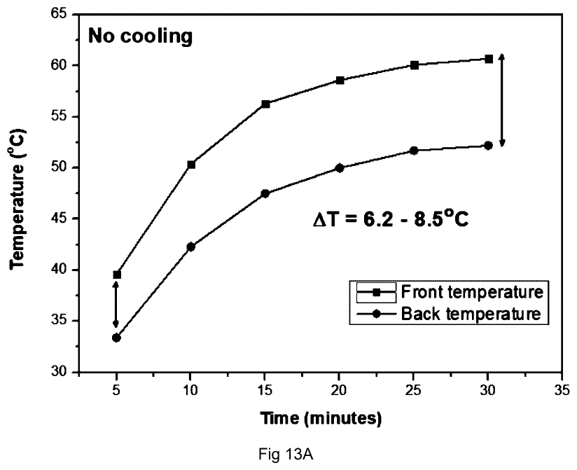

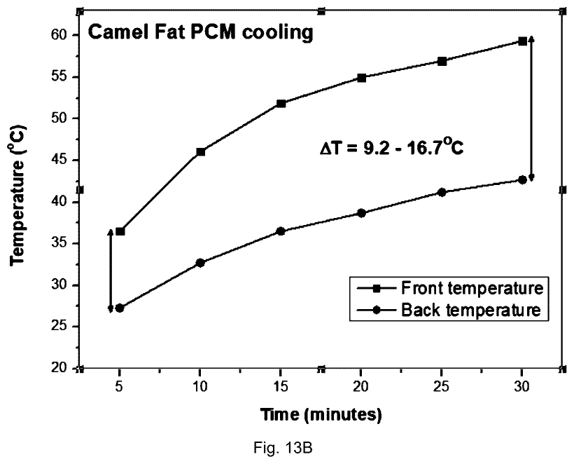

A comparison of the differences in front and back temperatures also revealed important findings. As depicted in FIG. 13A, for non-cooled PV panels, the temperature difference ranged from 6.2° C. to 8.5° C. However, for PCM-cooled PV panels, as shown in FIG. 13B, this range increased to 9.2° C. to 16.7° C. This indicates that the cooling system not only stabilized the panels' surface temperatures but also significantly altered the thermal gradient, enabling better thermal regulation under varying operational conditions.

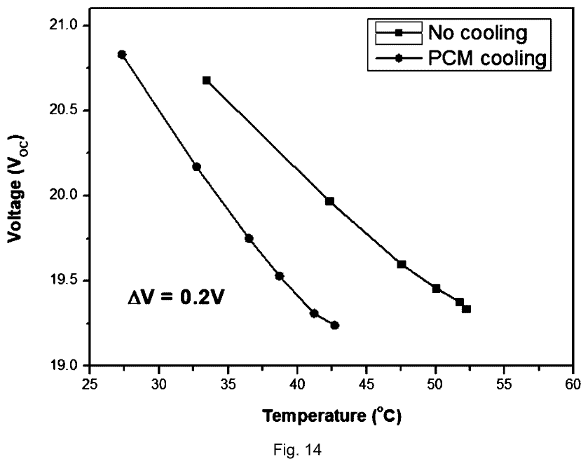

Thermal management improvements directly impacted the electrical performance of the PV panels. The open-circuit voltage (ΔV) difference between non-cooled and PCM cooled panels was approximately 0.2V, as shown in FIG. 14. While under typical conditions, this difference is modest, under maximum solar irradiation, ΔV is expected to increase to at least 1V, indicating a pronounced improvement in electrical efficiency with PCM cooling.

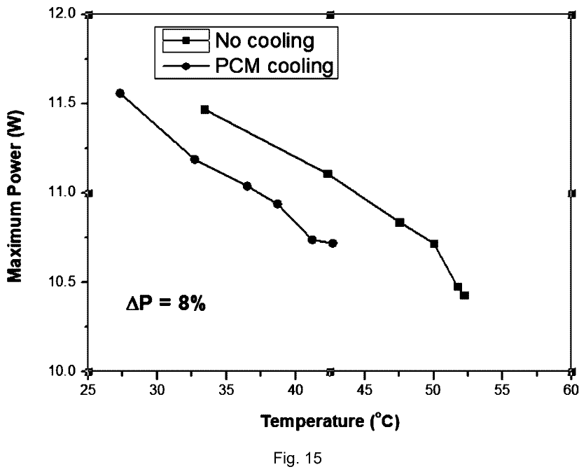

Similarly, the difference in maximum power output (ΔP) between non-cooled and PCM-cooled panels was about 8%, as illustrated in FIG. 15. Under optimal conditions with maximum solar irradiation, ΔP is expected to reach a 20% improvement. These observations highlight the potential of PCM integration to significantly enhance energy conversion efficiency by mitigating the detrimental effects of high temperatures on electrical performance.

The PCM-cooled panel demonstrated a clear reduction in surface temperature compared to the non-cooled reference panel. This thermal regulation directly impacted the panel's electrical performance, as the cooled panel exhibited higher open-circuit voltage and maximum power point values. Improvements in short-circuit current and maximum power current were also observed. The analysis revealed that the camel fat PCM effectively absorbed and stored heat, reducing the thermal load on the PV panel. The sustained reduction in temperature resulted in an enhancement in the panel's energy conversion efficiency. These results demonstrate the potential of camel fat-based PCMs to mitigate the adverse effects of heat on PV panels and improve their performance.

The preparation of purified camel fat for use as a phase change material (PCM) demonstrated its high thermal stability and latent heat capacity, making it suitable for effective thermal energy storage and release. Differential Scanning calorimetry (DSC) analysis confirmed the material's ability to undergo repeated phase transitions without significant degradation, ensuring its reliability for long-term applications. These characteristics highlight the potential of purified camel fat as a sustainable and efficient PCM for thermal management systems.

The latent heat capacities and maximum fusion temperatures of camel fat were observed to vary under different conditions. Bare camel fat exhibited a latent heat capacity of 100-110 J/g and a maximum fusion temperature of 48° C., with reduced stability at higher temperatures. Young camel fat showed similar properties with a slightly higher fusion temperature of 52° C. Purified camel fat demonstrated a significantly higher latent heat capacity of 120-140 J/g and a fusion temperature of 55° C., coupled with improved thermal stability. Hybrid camel fat with copper nanoparticles exhibited the highest latent heat capacity of 140-180 J/g and a fusion temperature that increased from 60° C. to 78° C. over five cycles. The behavior of the hybrid material, particularly the progressive increase in fusion temperature, is not yet fully understood and warrants further investigation. These findings emphasize the potential of camel fat, especially in purified and hybrid forms, as a sustainable and efficient PCM. The combination of high latent heat capacity, favorable fusion temperatures, and thermal stability positions camel fat-based PCMs as promising materials for energy storage and thermal management in various applications. Future work will focus on optimizing nanoparticle concentrations and exploring encapsulation techniques to further enhance their performance.

The results conclusively demonstrate the effectiveness of purified camel fat-based PCM in enhancing the performance of PV panels. The cooling mechanism effectively reduced both front and back panel temperatures, with ranges of 6.11° C. to 11.3° C. for back panels and 1.3° C. to 4.4° C. for front panels. The differences in temperature between the front and back panels further highlighted the improved thermal regulation, with non-cooled panels showing a difference of 6.2° C. to 8.5° C., while PCM-cooled panels exhibited a wider range of 9.2° C. to 16.7° C. In terms of electrical performance, PCM cooling resulted in an increase of approximately 0.2V in open-circuit voltage under standard conditions, which is expected to rise to at least 1V under maximum solar irradiation. The maximum power output saw an 8% improvement, with the potential to reach a 20% increase under optimal solar conditions.

It is important to note that the cooling of PV panels was only tested with purified camel fat and not with the hybrid camel fat enhanced with copper nanoparticles. The hybrid PCM, given its significantly higher latent heat capacity and fusion temperature, is expected to deliver even greater cooling performance and efficiency improvements. Future research will focus on validating these expectations by testing hybrid PCM in similar PV panel setups.

This study successfully validated the concept of using camel fat-based PCMs for cooling photovoltaic panels. The experimental setup provided reliable data, highlighting the cooling material's ability to enhance PV performance by maintaining lower operating temperatures. This approach offers a sustainable and cost-effective solution for improving the efficiency of PV panels in high-temperature environments, with potential applications in regions with intense solar exposure.

### Additional Examples

Embodiments of the present invention are also directed to a phase change material (PCM) comprising: camel fat as a base material; nanomaterials selected from the group consisting of copper nanoparticles, boron nitride nanoparticles, and carbon nanotubes; and metallized polyethylene terephthalate (MPET) for encapsulation to enhance structural stability and prevent leakage. The camel fat may be purified by rendering it with distilled water at approximately 90° C., followed by filtration and drying in a vacuum oven at about 65° C. the camel fat is hydrogenated by reacting it with hydrogen gas at 150 to 250 psi and 90° C. in the presence of a nickel catalyst to enhance its thermal stability. The nanomaterials are preferably dispersed into the camel fat matrix at concentrations ranging from about 2% to about 5% wt % using ultrasonic homogenization power of about 225 to about 450 W for about 10 to about 30 minutes. The nanomaterials may include copper nanoparticles with an average size of ranges from about 20 nm to about 800 nm, boron nitride nanoparticles with an average size of approximately 20 nm to about 800 nm, or carbon nanotubes. The nanomaterials may be introduced at different concentrations (e.g., 2 wt %, 3 wt %, and 5 wt %) to tailor the thermal conductivity and melting point for specific applications.

Embodiments of the present invention are also directed to methods of making a PCM, including the steps of: purifying camel fat by rendering and drying it; hydrogenating the camel fat to stabilize its chemical structure; infusing nanomaterials into the camel fat matrix using ultrasonic homogenization, and encapsulating the PCM in MPET pouches for enhanced durability. Preferably, the encapsulation involves sealing molten PCM in MPET pouches at room temperature, forming leak-proof modules of approximately about 5 to about 50 mm thickness. The latent heat of fusion preferably ranges from about 140 to about 180 J/g, and the melting temperature ranges from about 60° C. to about 78° C., depending on the nanomaterial concentration. The encapsulated PCM modules are preferably attached to the back of photovoltaic (PV) panels and capable of reducing operating temperatures of the PV by up to 15° C. and improve power output by approximately 20%. Pure camel fat may also be used for cooling purposes without the addition of nanomaterials, wherein the purified camel fat exhibits a latent heat of fusion of approximately 120 to 140 J/g and a melting temperature of about 55° C. The encapsulated PCM preferably demonstrates thermal cycling stability for at least 200 cycles without significant degradation in latent heat of fusion or melting temperature. The camel fat-based PCM is preferably biodegradable, non-toxic, and derived from renewable sources, making it suitable for environmentally friendly thermal management applications. The addition of nanomaterials may be performed so as to increase the thermal conductivity by at least 50% compared to pure camel fat. The encapsulated PCM modules may be incorporated into modular cooling systems designed for solar energy installations, refrigeration systems, or other thermal management systems. The PCM is preferably designed for low to moderate temperature applications, suitable for use in environments with operating temperatures ranging from 30° C. to 80° C. The addition of copper nanoparticles preferably improves the heat absorption and dissipation rate by increasing the effective thermal conductivity by at least 50% compared to pure camel fat. The encapsulated PCM modules may be shaped into any modular form, including panels, spheres, or other forms to suit specific thermal management systems. The PCM may be implemented in battery thermal management systems to regulate battery temperature during charging and discharging cycles. The PCM may be used for temperature-sensitive cooling applications, such as maintaining optimal temperatures for medical transport equipment or vaccines.

Interpreting this Specification

The examples described herein can be repeated with similar success by substituting the generically or specifically described components and/or operating conditions of embodiments of the present invention for those used in the preceding examples.

Note that in the specification and claims, “about” or “approximately” means within twenty percent (20%) of the numerical amount cited.

Embodiments of the present invention can include every combination of features that are disclosed herein independently from each other. The processes, methods and materials of each example may be substituted between examples. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. The terms, “a”, “an”, “the”, and “said” mean “one or more” unless context explicitly dictates otherwise.

What is claimed is:

1. A phase change material (PCM) comprising:
camel fat; and
nanomaterials selected from the group consisting of copper nanoparticles, boron nitride nanoparticles, and carbon nanotubes.

2. The PCM according to claim 1, wherein the PCM is encapsulated in metallized polyethylene terephthalate (MPET).

3. The PCM according to claim 2, wherein the encapsulated PCM demonstrates thermal cycling stability for at least 200 cycles without significant degradation in latent heat of fusion or melting temperature.

4. The PCM according to claim 1, wherein the nanomaterials are dispersed in the camel fat at concentrations ranging from about 2% to about 5% wt %.

5. The PCM according to claim 1, wherein the nanomaterials comprise:
copper nanoparticles with an average size of about 20 nm to about 800 nm,
boron nitride nanoparticles with an average size of about 20 nm to about 800 nm, or carbon nanotubes.

6. The PCM according to claim 1, wherein the latent heat of fusion of the PCM ranges from about 140 to about 180 J/g, and the melting temperature ranges from about 60° C. to about 78° C.

7. The PCM according to claim 1, wherein the copper nanoparticles improve the heat absorption and dissipation rate of the PCM by increasing the effective thermal conductivity of the PCM by at least 50% compared to pure camel fat.

8. A method of making a phase change material (PCM), the method comprising:
purifying camel fat;
hydrogenating the camel fat; and
infusing nanomaterials into the camel fat.

9. The method of claim 8, wherein the step of purifying the camel fat comprises rendering it with distilled water at approximately 90° C., followed by filtration and drying in a vacuum oven at about 65° C.

10. The method of claim 8, wherein the step of hydrogenating the camel fat comprises reacting it with hydrogen gas at about 150 to about 250 psi and about 90° C. in the presence of a nickel catalyst to enhance its thermal stability.

11. The method of claim 8, wherein the step of infusing the nanomaterials comprises dispersing the nanomaterials in the camel fat at concentrations ranging from about 2% to about 5% wt % using ultrasonic homogenization power of about 225 to about 450 W for about 10 to about 30 minutes.

12. The method of claim 8, wherein the step of infusing the nanomaterials comprises introducing the nanomaterials at different concentrations to tailor the thermal conductivity and melting point of the PCM for specific applications.

13. The method of claim 8, wherein the step of infusing the nanomaterials increases the thermal conductivity of the PCM by at least about 50% compared to pure camel fat.

14. The method of claim 8, further comprising encapsulating the PCM in metallized polyethylene terephthalate (MPET).

15. The method of claim 14, further comprising attaching the encapsulated PCM to photovoltaic (PV) panels.

16. The method of claim 14, further comprising incorporating the encapsulated PCM into a cooling system designed for solar energy installations, a refrigeration system, or other thermal management systems.

17. The method of claim 14, further comprising shaping the encapsulated PCM into modular forms to coordinate with photovoltaic (PV) panels, thermal management systems or temperature-sensitive cooling applications.

18. The method of claim 14, further comprising incorporating the encapsulated PCM in battery thermal management systems to regulate battery temperature during charging and discharging cycles.

19. The method of claim 8:
wherein the step of purifying the camel fat comprises rendering it with distilled water at approximately 90° C., followed by filtration and drying in a vacuum oven at about 65° C.;
wherein the step of infusing the nanomaterials comprises dispersing the nanomaterials in the camel fat at concentrations ranging from about 2% to about 5% wt % using ultrasonic homogenization power of about 225 to about 450 W for about 10 to about 30 minutes; and
wherein the method further comprises encapsulating the PCM in metallized polyethylene terephthalate (MPET).

20. A phase change material (PCM) comprising camel fat, wherein the PCM exhibits a latent heat of fusion of about 120 to about 140 J/g and a melting temperature of about 55° C., wherein the PCM is encapsulated in metallized polyethylene terephthalate (MPET) shaped in a modular form capable of integration into thermal management systems or temperature-sensitive cooling applications.
